(19) United States
(12) Patent Application Publication
(10) Pub. No.: US 2020/0010580 A1
(43) Pub. Date: Jan. 9, 2020

(54) THREE-DIMENSIONAL MODELING COMPOSITION SET, THREE-DIMENSIONAL MODEL MANUFACTURING METHOD, AND THREE-DIMENSIONAL MODELING APPARATUS

(71) Applicants: Yoshihito SHIMADA, Kanagawa (JP); Yoshihiro NORIKANE, Kanagawa (JP); Kenji SUGIURA, Kanagawa (JP); Hiroyuki NAITO, Tokyo (JP)

(72) Inventors: Yoshihito SHIMADA, Kanagawa (JP); Yoshihiro NORIKANE, Kanagawa (JP); Kenji SUGIURA, Kanagawa (JP); Hiroyuki NAITO, Tokyo (JP)

(73) Assignee: Ricoh Company, Ltd., Tokyo (JP)

(21) Appl. No.: 16/482,454

(22) PCT Filed: Mar. 23, 2018
(86) PCT No.: PCT/JP2018/011800

§ 371 Date: Jul. 31, 2019

(30) Foreign Application Priority Data
Mar. 29, 2017 (JP) 2017-065570

(51) Int. Cl. C08F 2/48; B29C 64/40

(52) U.S. Cl. CPC C08F 2/48; B33Y 10/00; B29C 64/40

(57) ABSTRACT

A disclosed three-dimensional modeling composition set includes a first composition, and a second composition, where at least one of a cured product of the first composition and a cured product of the second composition has water disintegratability, and when ST1 represents surface tension of the first composition and ST2 represents surface tension of the second composition, the following formula (1) is satisfied: IST1−ST2I≤2 (1) where in the formula (1), the unit of the surface tension is mN/m. A method and an apparatus using the three-dimensional modeling composition set are also disclosed.

### TECHNICAL FIELD

The disclosures discussed herein relate to a three-dimensional modeling composition set, a three-dimensional model manufacturing method, and a three-dimensional modeling apparatus.

### BACKGROUND ART

Additive manufacturing (AM: Additive Manufacturing) is known as a method for modeling a three-dimensional solid object. This method includes forming layers having a cross-section of a three-dimensional model cut at predetermined intervals, and laminating such layers to model a three-dimensional object. Examples of known techniques for modeling a three-dimensional object include a material jet system using an ink jet recording apparatus, a fused deposition molding (FDM) method, a binder jet method, a stereo lithography apparatus (SLA), and a selective laser sintering (SLS), and the like. The material jet system is configured to discharge a curable composition to form a liquid film, cure the liquid film to form a layer having a single cross section, and laminate the formed layers to form a three-dimensional object. There is a known technique in modeling a three-dimensional shape having an overhang part by a material jet system, in which the model part of the overhang part is shaped while being supported by the support part.

Patent Document 1 discloses that a model material and a support material are integrally formed at the time of the completion of forming a three-dimensional model, and that this support material is made of a water-soluble material so that the model material alone is obtained by being immersed in water. Patent Document 1 also discloses that when the weighted average value of the SP value of a curable resin component of a model material exceeds 10.3, a cured product of the model material swells and deforms with water, and that when the SP value is less than 9.0, the cured product becomes brittle and its toughness lowers. In addition, Patent Document 1 discloses acryloyl morpholine as a component of a model material.

Patent Document 2 discloses that a three-dimensional modeling apparatus is provided with a roller in order to smooth a surface of a model material by pressing the surface of the discharged model material and the support material that are uncured to remove the surplus of the modeling material.

### CITATION LIST

### Patent Literature

[PTL 1] Japanese Unexamined Patent Application Publication No. 2012-111226

[PTL 2] Japanese Patent No. 5685052

### SUMMARY OF INVENTION

### Technical Problem

For example, acryloyl morpholine has photocurability and provides excellent cured product strength and elongation performance; acryloyl morpholine may thus be used as a model material. In addition, acryloyl morpholine has high hydrophilicity and high water solubility; acryloyl morpholine may also be used as a support material. However, using the same type of polymers for both the model material and the support material may result in a rough interface between the model material and the support material, despite modeling being performed while smoothing with a roller or the like. Accordingly, it is difficult to remove the support part formed of the support material from the model part formed of the model material; this may result in the lowered transparency of the model part.

### Solution to Problem

According to an embodiment, a three-dimensional modeling composition set includes a first composition; and a second composition, where at least one of a cured product of the first composition and a cured product of the second composition has water disintegratability, and when ST1 represents surface tension of the first composition and ST2 represents surface tension of the second composition, the following formula (1) is satisfied:

|ST1−ST2|≤2 (1)

wherein in the formula (1), the unit of the surface tension is mN/m.

### Advantageous Effect of Invention

According to an embodiment of the present invention, it is possible to obtain a three-dimensional model having excellent smoothness and transparency.

### BRIEF DESCRIPTION OF DRAWINGS

FIG. 1 is a schematic diagram illustrating a modeling apparatus according to one embodiment;

FIG. 2A is a perspective diagram illustrating an example of a three-dimensional model.

FIG. 2B is a perspective diagram illustrating an example of a model having a model part 10 with an overhang part being supported by a support part

FIG. 2C is a cross-sectional diagram illustrating one section of the model of FIG. 2B.

FIG. 3 is a perspective diagram illustrating an example of a model.

### DESCRIPTION OF EMBODIMENTS

The following describes an embodiment of the present invention. According to embodiments of the present invention, it is possible to provide a model having excellent smoothness and transparency by controlling a relationship between surface tensions of two compositions used for modeling, that is, by controlling wettability.

### Compositions for Three Dimensional Modeling

In one embodiment of the present invention, a set of compositions for three-dimensional modeling (also referred to as a “three-dimensional modeling composition set”) includes a composition A (an example of a first composition) and a composition B (an example of a second composition). The set of three-dimensional modeling compositions is hereinafter simply referred to as a “set of compositions”. This set of compositions is suitably used in various additive manufacturing (AM: Additive Manufacturing) in which a model part is modelled while being supported by a support part.

One of the composition A and the composition B is a model material used for forming the model part and the other one of the composition A and the composition B is a support material used for forming the support part. The composition A and the composition B are liquids, which are cured while having an interface to each other. At least one of a cured product of the composition A and a cured product of the composition B has water disintegratability. Further, when STa (an example of ST1) represents surface tension of the composition A and STb (an example of ST2) represents surface tension of the composition B, the set of the compositions satisfies the following formula (1), and preferably satisfies the following formulas (1) to (3):

|STa−STb|≤2 (1)

28≤STa≤40 (2)

28≤STb≤40 (3)

where in the formulas (1) to (3), the unit of the surface tension is mN/m.

In the following description, any one of composition A and composition B may simply be referred to as a “composition”.

One of the compositions of an embodiment of the present invention preferably has water disintegratability. The term “water disintegratability” indicates that a cured product is finely broken down when the cured product is immersed in water, and is no longer able to maintain the originally possessed shape and properties. In an embodiment of the present invention, a room temperature indicates, for example, a temperature range between 20° C. or more and 40° C. or less.

An active energy ray curable liquid composition of an embodiment of the present invention may, for example, preferably satisfy at least one of the following conditions A to C for water disintegratability.

Condition A

When a cured product of 20 mm in length×20 mm in width×5 mm in height obtained by being irradiated with active energy rays at 500 mJ/cm² is placed in 20 mL of water, and ultrasonic waves are applied to the cured product for 30 minutes at either 40° C. or 60° C., the volume of a residual solid is 50 vol % or less.

Condition B

When a cured product of 20 mm in length×20 mm in width×5 mm in height obtained by being irradiated with active energy rays at 500 mJ/cm² is placed in 20 mL of water and left to stand at 25° C. for 1 hour, the volume of a residual solid is 90 vol % or less.

Condition C

When a cured product of 20 mm in length×20 mm in width×5 mm in height obtained by being irradiated with active energy rays at 500 mJ/cm² is placed in 20 mL of water and left to stand at 25° C. for 1 hour, a resulting solid has a size of at least one side being 1 mm or less, or the resulting solid has completely dissolved.

Note that the cured product of 20 mm in length×20 mm in width×5 mm in height under the conditions A to C may be produced as follows.

An active energy ray curable liquid composition is poured into a silicone rubber mold having a size of 20 mm in length×20 mm in width×5 mm in height, and ultraviolet rays are applied at an irradiation dose of 500 mJ/cm² (illuminance: 100 mW/cm², irradiation time: 5 seconds) using an ultraviolet irradiation device (device name: SubZero-LED, manufactured by Integration Technology Co.) to thereby obtain a cured product, becoming the support part, of 20 mm in length×20 mm in width×5 mm in height.

The volume of the residual solid in the condition B is preferably 90 vol % or less, more preferably 50 vol % or less, and particularly preferably 30 vol % or less. The volume of the residual solid may be measured by the Archimedes method.

At least one of the composition A and the composition B is preferably an active energy ray curable material, which is cured by the application of active energy rays such as ultraviolet rays and infrared rays. Accordingly, the composition A and the composition B contain a curable monomer and a photopolymerization initiator. In addition, the composition A and the composition B may contain a polymer, a solvent, a surfactant, and the like. Further, the composition A and the composition B contain other components such as a surfactant, a defoaming agent, a viscosity adjusting agent, a polymerization inhibitor, a pigment, and a dye, as required.

Curable Monomers

Monomers having curability or curable monomers are not particularly specified and may be appropriately selected according to the intended use or purpose; examples of such curable monomers include a monofunctional monomer and a polyfunctional monomer. One type of the curable monomers may be used alone, or two or more types of the curable monomers may be used in combination. The content of the curable monomers is preferably 40 mass % or more and 95 mass % or less, with respect to a total amount of the composition.

Examples of the curable monomers include (meth)acrylate such as aliphatic hydrocarbon (meth)acrylate, polyfunctional aliphatic compound, epoxy monomer and the like. Examples of the aliphatic hydrocarbon (meth)acrylate include straight-chain ethyl (meth)acrylate, butyl (meth)acrylate, 3-methoxybutyl (meth)acrylate, tridecyl (meth)acrylate, lauryl (meth)acrylate, stearyl (meth)acrylate, 2-phenoxyethyl (meth)acrylate, caprolactone (meth)acrylate and ethoxylated nonylphenol; branched n-butyl (meth)acrylate, 2-ethylhexyl (meth)acrylate (EHA), isooctyl (meth)acrylate and isodecyl; and cyclic aliphatic isobornyl (meth)acrylate and cyclohexyl (meth)acrylate. Examples of the polyfunctional aliphatic compound include ethylene glycol (meth)acrylate, triethylene glycol di(meth)acrylate, trimethylolpropane tri(meth)acrylate and the like. Examples of epoxy monomers include ethylene glycol diglycidyl ether, diethylene glycol diglycidyl ether, propylene glycol diglycidyl ether, bisphenol A glycidyl ether, hydrogenated bisphenol A glycidyl ether, and the like.

Monomers having two or more reactive groups such as glycidyl (meth)acrylate and tetrahydrofuryl (meth)acrylate may also be used as curable monomers. Examples of the curable monomers include monomers having an amide group such as (meth)acrylamide, dimethyl (meth)acrylamide and (meth)acryloyl morpholine, and heterocyclic vinyl compounds such as N-vinyl caprolactam and N-vinyl carobazole. The curable monomers may have a carbonyl group, a carboxyl group, a nitro group, a sulfone group, or the like.

Examples of polymerization reactions of the curable monomers include radical polymerization, ionic polymerization, coordination polymerization, ring-opening polymerization and the like. Among these polymerization reactions, radical polymerization is preferable from a viewpoint of controlling the reaction. Of the compositions, the support material preferably contains a monomer having a hydrogen bonding property as a monomer having curability in order to have water solubility.

As monomers having a hydrogen bonding property, an ethylenically unsaturated monomer is preferable, a water-soluble monofunctional ethylenically unsaturated monomer and a water-soluble polyfunctional ethylenically unsaturated monomer are more preferable, and a low viscosity cyclic compound is still more preferable.

Examples of water-soluble monofunctional ethylenically unsaturated monomers include monofunctional vinyl amide group-containing monomers; monofunctional hydroxyl group-containing (meth)acrylates; hydroxyl group-containing (meth)acrylates; (meth)acrylamide derivatives, (meth)acryloyl morpholine and the like. One type of the water-soluble monofunctional ethylenically unsaturated monomers may be used alone, or two or more types of the water-soluble monofunctional ethylenically unsaturated monomers may be used in combination.

Examples of monofunctional vinylamide group-containing monomers include N-vinyl-ε-caprolactam, N-vinylformamide, N-vinylpyrrolidone and the like. Examples of the monofunctional hydroxyl group-containing (meth)acrylate include hydroxyethyl (meth)acrylate, hydroxypropyl (meth)acrylate, 4-hydroxybutyl (meth)acrylate and the like. Examples of hydroxyl group-containing (meth)acrylates include polyethylene glycol mono(meth)acrylate, monoalkoxy (C1-C4) polyethylene glycol mono(meth)acrylate (C represents the number of carbon atoms, the same applies hereinafter), polypropylene glycol mono(meth)acrylate, monoalkoxy (C1-C4) polypropylene glycol mono(meth)acrylate, and mono(meth)acrylate of PEG-PPG block polymer and the like. Examples of (meth)acrylamide derivatives include (meth)acrylamide, N-methyl (meth)acrylamide, N-ethyl (meth)acrylamide, N-propyl (meth)acrylamide, N-butyl (meth)acrylamide, N,N′-dimethyl (meth)acrylamide, N-hydroxyethyl (meth)acrylamide, N-hydroxypropyl (meth)acrylamide, and N-hydroxybutyl (meth)acrylamide.

Among these, (meth)acrylate and (meth)acrylamide derivatives are preferable from a viewpoint of photoreactivity; hydroxyethyl (meth)acrylate, hydroxypropyl (meth)acrylate, 4-hydroxybutyl (meth)acrylate, (meth)acrylamide, (meth)acryloyl morpholine, N-methyl (meth)acrylamide, N-ethyl (meth)acrylamide, N-propyl (meth)acrylamide, N-butyl (meth)acrylamide, N, N′-dimethyl (meth)acrylamide, N-hydroxyethyl (meth)acrylamide, N-hydroxypropyl (meth)acrylamide, N-hydroxybutyl (meth)acrylamide, and diethyl (meth)acrylamide are more preferable; and (meth)acryloyl morpholine and N-hydroxyethyl (meth)acrylamide are specifically preferable from a viewpoint of skin irritation to the human body.

Examples of water-soluble polyfunctional ethylenically unsaturated monomers include a bifunctional monomer and a trifunctional or higher monomer. One type of the water-soluble ployfunctional ethylenically unsaturated monomers may be used alone, or two or more types of the water-soluble polyfunctional ethylenically unsaturated monomers may be used in combination.

Examples of bifunctional monomers include tripropylene glycol di(meth)acrylate, triethylene glycol di(meth)acrylate, tetraethylene glycol di(meth)acrylate, polypropylene glycol di(meth)acrylate, neopentyl glycol hydroxypivalic acid ester di(meth)acrylate (MANDA), hydroxypivalic acid neopentyl glycol ester di(meth)acrylate (HPNDA), 1,3-butanediol di(meth)acrylate (BGDA), 1,4-butanediol di(meth)acrylate (BUDA), 1,6-hexanediol di(meth)acrylate (HDDA), 1,9-nonanediol di(meth)acrylate, diethylene glycol di(meth)acrylate (DEGDA), neopentyl glycol di(meth)acrylate (NPGDA), tripropylene glycol di(meth)acrylate (TPGDA), caprolactone-modified hydroxypivalic acid neopentyl glycol ester di(meth)acrylate, propoxylated octyl glycol di(meth)acrylate, polyethylene glycol 200 di(meth)acrylate, and polyethylene glycol 400 di(meth)acrylate and the like. Examples of trifunctional or higher monomers include triallyl isocyanate, dimethylol-tricyclodecane di(meth)acrylate, and tris(2-hydroxyethyl) isocyanurate tri(meth)acrylate.

### Photopolymerization Initiators

As a photopolymerization initiator, any substance that generates radicals upon irradiation with light, particularly ultraviolet rays having a wavelength of 220 to 400 nm, may be used. Examples of such a photopolymerization initiator include acetophenone, 2,2-diethoxyacetophenone, p-dimethylaminoacetophenone, benzophenone, 2-chlorobenzophenone, p,p′-dichlorobenzophenone, p,p-bisdiethylaminobenzophenone, michler's ketone, benzyl, benzoin, benzoin methyl ether, benzoin ethyl ether, benzoin isopropyl ether, benzoin-n-propyl ether, benzoin isobutyl ether, benzoin-n-butyl ether, benzyl methyl ketal, thioxanthone, 2-chlorothioxanthone, 2-hydroxy-2-methyl-1-phenyl-1-one, 1-(4-isopropylphenyl)-2-hydroxy-2-methylpropan-1-one, methyl benzoyl formate, 1-hydroxycyclohexyl phenyl ketone, azobisisobutyronitrile, benzoyl peroxide, and ditert-butyl peroxide and the like.

One type of these photopolymerization initiators may be used alone, or two or more types of these photopolymerization initiators may be used in combination. Among these, it is preferable to select a photopolymerization initiator adjusted to the ultraviolet wavelength of the ultraviolet irradiation device used for modeling. The content of the photopolymerization initiator is preferably 0.5% by mass or more and 10% by mass or less with respect to a total amount of the composition.

Polymers

Polymers used in the composition for three dimensional modeling may be a curable polymer or a non-curable polymer, and may be appropriately selected in consideration of the strength of the model and removability of the support part. Typically, a curable polymer is used for a model material, and a non-curable polymer is used for a support material, however, polymers suitable for the purpose may be used.

Examples of the curable polymers include urethane acrylates and polyacrylates. Urethane acrylates are obtained by reacting hydroxyacrylate with isocyanate.

Examples of hydroxy acrylates include 2-hydroxyethyl (meth)acrylates, 2-hydroxy (iso)propyl (meth)acrylates, 2-hydroxybutyl (meth)acrylates and 4-hydroxybutyl (meth)acrylates alone. As the hydroxy acrylates, an extended hydroxyacrylate obtained by elongating hydroxyacrylates may also be used. The elongation reaction is performed by adding diol, alkyloxide, and caprolactone to hydroxyacrylate to introduce any alkylene oxide group.

Among the isocyanates, as poly(di, tri or higher) isocyanates, examples such as aromatic polyisocyanate, aliphatic polyisocyanate, alicyclic polyisocyanate, araliphatic polyisocyanate, polyisocyanurate products of the above, and mixtures of the above, and the like may be given.

Examples of the aromatic polyisocyanates include compounds having C6 to C20 (the number of the carbon atoms excludes those contained in NCO groups, which will be the same in the following description of isocyanate) such as 2,4-tolylene diisocyanate, 2,6-tolylene diisocyanate (TDI), 4,4′-diphenylmethane diisocyanate, and 2,4′-diphenylmethane diisocyanate (MDI). Examples of the aliphatic polyisocyanate include compounds having C2 to C18, such as hexamethylene diisocyanate (HDI). Examples of the alicyclic polyisocyanates include compounds having C4 to C45 such as isophorone diisocyanate (IPDI), 2,4-methylcyclohexane diisocyanate, 2,6-methylcyclohexane diisocyanate (hydrogenated TDI), and dicyclohexylmethane-4,4′-diisocyanate (hydrogenated MDI) and the like. Examples of the araliphatic polyisocyanates include compounds having C8 to C15 such as m-xylylene diisocyanate, p-xylylene diisocyanate (XDI), α,α,α′,α′-tetramethylxylylene diisocyanate (TMXDI), and the like.

Commercially available urethane acrylates may also be used. Examples of commercially available urethane acrylates include AH-600, UA-306H, UA-306T, UA3061, UA-510H, UF-8001G, DAUA-167 (manufactured by Kyoeisha Chemical Co., Ltd.); UA-390, U-200PA, UA-160™, UA-290™, UA-4200, UA-3900, UA-360P, U-2PPA, U-6 LPA, U-10HA, U-4400, UA-122P (manufactured by Nakamura Chemical Industry Co., Ltd.); and Photomer 6008, Photomer 6010, Photomer 6019, Photomer 6184, and Photomer 6210 (manufactured by BASF).

Examples of the non-curable polymer include alkylene oxide adduct, polyester, polyethylene, polypropylene, polyamide, polyacryl, and copolymers of crylic acid and styrene. In a case where the composition is used for forming a support material, an alkylene oxide adduct is preferable for a non-curable polymer, which more preferably has the number of carbon atoms of 2 or more to 6 or less and a weight average molecular weight of 5,000 or less, from a viewpoint of the viscosity of the composition.

Solvents

Examples of a solvent used for a composition for three-dimensional modeling include a solvent containing a functional group such as a monoalcohol, a polyol such as a diol, a hydrocarbon, a carboxylic acid, an ester, a ketone, an amine or the like. The support material preferably contains an alcohol in order to enhance water solubility.

### Surfactants

At least one of the composition A and the composition B preferably contains a surfactant. When at least one of the composition A and the composition B contains a surfactant, surface tension of one of the compositions A and B having a high surface tension is lowered, thereby providing an advantageous effect of reducing the difference in the surface tension between the composition A and the composition B. Examples of the surfactant used in such a composition for three-dimensional modeling include anionic surfactant, cationic surfactant, amphoteric surfactant, and nonionic surfactant in the classification of the hydrophilic group. Any of these surfactants may be used; however, an anionic surfactant which is generally available is preferred. As the surfactant, a hydrocarbon-based surfactant, a silicone-based surfactant, a fluorine-based surfactant and the like in the classification of a hydrophobic group may be given. Any of these surfactants may be used; however, silicone-based surfactants are preferred from a viewpoint of solubility in the composition. A wide variety of silicone-based surfactants may be given; however, silicone-based surfactants having a nonvolatile content of 80% or more are preferable from a viewpoint of odor and VOC (Volatile Organic Compounds) at the time of modeling. Examples of commercially available silicone-based surfactants include BYK-302, BYK-307, BYK-333, BYK347, BYK-348, BYK-349, BYK-377, and BYK-3455.

Other Components

Other components are not particularly specified and may be appropriately selected according to the purpose; examples of other components include a polymerization inhibitor, a mineral that is dispersible in the composition, a thermal polymerization initiator, a colorant, an antioxidant, a chain transfer agent, an anti-aging agent, a crosslinking accelerator, an ultraviolet absorber, a plasticizer, a preservative, a dispersant and the like.

Polymerization Inhibitors

Examples of the polymerization inhibitors include phenol compounds, sulfur compounds, phosphorus compounds, and the like. Examples of the phenol compounds include hydroquinone, hydroquinone monomethyl ether, 2,6-di-t-butyl-p-cresol, 2,2-methylene-bis-(4-methyl-6-t-butylphenol), 1,1,3-tris-(2-methyl-4-hydroxy-5-t-butylphenyl) butane and the like. Examples of the sulfur compounds include dilauryl thiodipropionate and the like. Examples of the phosphorus compounds include triphenyl phosphite and the like. One type of these phosphorus compounds may be used alone, or two or more types of these phosphorus compounds may be used in combination.

The content of the polymerization inhibitors is not particularly specified; however, from the viewpoint of compressive stress, the preferable content may be 30 mass % or less or more preferable content may be 20 mass % or less, with respect to the total amount of the composition.

Minerals Dispersible in Composition

Minerals that may be dispersed in the composition are not particularly specified and may be appropriately selected according to the intended use or purpose; examples of such minerals include layered clay minerals and the like.

Examples of layered clay minerals include smectites such as montmorillonite, beidellite, hectorite, saponite, nontronite, and stevensite; vermiculite; bentonite; and layered sodium silicate such as kanemite, kenyanite, and macanite. One type of these layered clay minerals may be used alone, or two or more types of these layered clay minerals may be used in combination. The layered clay minerals may be a natural mineral or a chemically synthesized mineral obtained by a chemical synthetic procedure.

The surface of the layered clay mineral may be subjected to organic treatment. Layered inorganic substances such as layered clay minerals are treated with organic cationic compounds, and cations between the layers are ion-exchanged with cationic groups such as quaternary salts. Examples of cations of the layered clay mineral include metal cations such as sodium ions and calcium ions. The layered clay mineral treated with the organic cationic compound tends to become swollen or dispersed in the above-described polymers or polymerizable monomers.

Examples of the layered clay mineral treated with the organic cationic compound include the Lucentite series (manufactured by CO-OP Chemical Co., Ltd.) and the like. Examples of the Lucentite series (manufactured by Co-op Chemical Co., Ltd.) include Lucentite SPN, Lucentite SAN, Lucentite SEN, Lucentite STN, and the like. One type of these may be used alone, or two or more types of these may be used in combination.

Colorants

Examples of colorants include pigments and dyes. Examples of pigments include organic pigments and inorganic pigments. Examples of the organic pigments include an azo pigment, a polycyclic pigment, an azine pigment, a daylight fluorescent pigment, a nitroso pigment, a nitro pigment, a natural pigment and the like. Examples of the inorganic pigments include metal oxides such as iron oxide, chromium oxide, and titanium oxide, carbon black, and the like.

Antioxidants

Examples of the polymerization inhibitors include phenol compounds, sulfur compounds, phosphorus compounds, and the like. Examples of an antioxidant include a phenol compound, a sulfur compound, a phosphorus compound, and the like. Examples of the phenolic compound include monocyclic phenols such as 2,6-di-t-butyl-p-cresol, bisphenols such as 2,2′-methylenebis(4-methyl-6-t-butylphenol), and polycyclic phenols such as 1,3,5-trimethyl-2,4,6-tris(3,5-di-t-butyl-4-hydroxybenzyl) benzene, and the like. Examples of the sulfur compound include dilauryl 3,3′-thiodipropionate and the like. Examples of the phosphorus compound include triphenyl phosphite and the like. Examples of the amine compound include octylated diphenylamine and the like.

### Chain Transfer Agents

Examples of the chain transfer agents include hydrocarbons, halogenated hydrocarbons, alcohols, thiols, ketones, aldehydes, phenols, quinones, amines, and disulfides.

The number of carbon atoms of the hydrocarbons may be in a range between 6 or more and 24 or less. Examples of the hydrocarbon having the number of carbon atoms between 6 or more and 24 or less include aromatic hydrocarbons such as toluene and xylene; and unsaturated aliphatic hydrocarbons such as 1-butene and 1-nonene. The number of carbon atoms of the halogenated hydrocarbon may be in a range between 1 or more and 24 or less. Examples of the halogenated hydrocarbon having the number of carbon atoms between 1 or more and 24 or less include dichloromethane, carbon tetrachloride and the like.

The number of carbon atoms of the alcohols may be in a range between 1 or more and 24 or less. Examples of the alcohol having the number of carbon atoms between 1 or more and 24 or less include methanol, 1-butanol and the like. The number of carbon atoms of the thiol may be in a range between 1 or more and 24 or less. Examples of the thiol having the number of carbon atoms between 1 or more and 24 or less include ethyl thiol, 1-octyl thiol and the like.

The number of carbon atoms of the ketones may be in a range between 3 or more and 24 or less. Examples of the ketones having the number of carbon atoms between 3 or more and 24 or less include acetone and methyl ethyl ketone. The number of carbon atoms of the aldehydes may be in a range between 2 or more and 18 or less. Examples of the aldehydes having the number of carbon atoms between 2 or more and 18 or less include 2-methyl-2-propyl aldehyde, 1-pentyl aldehyde and the like.

The number of carbon atoms of the phenols may be in a range between 6 or more and 36 or less. Examples of the phenols having the number of carbon atoms between 6 or more and 36 or less include phenol, m-cresol, p-cresol, o-cresol and the like. The number of carbon atoms of the quinones may be in a range between 6 or more and 24 or less. Examples of the quinones having the number of carbon atoms between 6 or more and 24 or less include hydroquinone and the like.

The number of carbon atoms of the amines may be in a range between 3 or more and 24 or less. Examples of the amines having the number of carbon atoms between 3 or more and 24 or less include diethyl methyl amine, diphenyl amine and the like. The number of carbon atoms of the disulfides may be in a range between 2 or more and 24 or less. Examples of the disulfides having the number of carbon atoms between 2 or more and 24 or less include diethyl disulfide, and di-1-octyl disulfide and the like.

### Set of Composition A and Composition B

The composition A and the composition B are each cured while having an interface to each other to be used as a model material or a support material. Of the composition A and the composition B, the composition used as a support material has water disintegratability. The water disintegratability is a disintegrating property by being immersed in water.

When STa represents surface tension of the composition A and STb represents surface tension of the composition B, the set of the composition A and the composition B satisfies the formula (1), and preferably satisfies formulas (1) to (3):

|STa−STb|≤2 (1)

28≤STa≤40 (2)

28≤STb≤40 (3)

In the formulas (1) to (3), the unit of the surface tension is mN/m.

Further, as illustrated in the formula (1), when the surface tension (STa) of the composition A and the surface tension (STb) of the composition B do not satisfy the formula (1), droplets of one of the composition A and the composition B become spread out, which may be likely to form an uneven interface between the composition A and the composition B. When the surface tension (STa) of the composition A and the surface tension (STb) of the composition B satisfy the formula (1), droplets of the composition A and the composition B do not spread out, which will form a smooth interface between the composition A and the composition B. When the composition A and the composition B are cured while maintaining a smooth interface between the composition A and the composition B, the interface between the model part and the support part becomes smooth, which may facilitate removability of the support part; this may improve the transparency of the obtained model.

As illustrated in the formulas (2) and (3), the surface tensions of the composition A and the composition B each preferably fall within a range between 28 mN/m or more and 40 mN/m or less. When the surface tensions of the composition A and the composition B are 28 mN/m or more, unstable ejection such as bending in an ejecting direction and ejection incapability during modeling may be prevented. When the surface tensions of the composition A and the composition B are 40 mN/m or less, the compositions may readily become filled into modeling nozzles or the like.

The surface tensions of the composition A and the composition B may be measured using a surface tension meter (automatic surface tension meter DY-300, manufactured by Kyowa Interface Science Co., Ltd.), for example. Specifically, the surface tensions of the composition A and the composition B may be measured by pulling a platinum plate at 1 mm/s under an ambient temperature of 23° C.±2° C. The surface tension of each composition may be measured five times, with the average value calculated from the three points from the top.

The weight average hSP value (Hansen solubility parameter of the composition A is preferably 19 MPa^{0.5} or less, and the weight average hSP value of the composition B is preferably 20 MPa^{0.5} or more. The weight average hSP value is obtained by multiplying the hSP value of each component contained in the composition and the content (wt %) of each component, and adding obtained multiplication results. As the hSP value of each component, a known value may be used. In calculation of the weight average hSP value, the hSP value of minor components of less than 1 wt % in the composition need not to be considered because such an hSP value does not have a significant effect on the results. Setting the hSP values of the composition A and the composition B to the above preferred ranges may control against mixing of the two compositions, thereby providing an advantageous effect of a smooth flat surface.

Further, the difference between the weight average hSP value of the composition A and the weight average hSP value of the composition B is preferably 0.6 MPa^{0.5} or more. Setting the difference between the weight average hSP value of the composition A and the weight average hSP value of the composition B to 0.6 MPa^{0.5} or more, and more preferably to 1.3 MPa^{0.5} or more may control against mixing of the two compositions, thereby providing an advantageous effect of improved removability of the support part.

(Meth)acrylic monomers and (meth)acrylamide monomers are useful as a model material for improving the strength and elongation of the cured product, exhibit high hydrophilicity and high water solubility, and are also useful as a support material. (Meth)acrylic represents at least one of acrylic and methacrylic. The composition A and the composition B preferably contain a common (meth)acrylic monomer or a common (meth)acrylamide monomer. Examples of the common (meth)acrylic monomer include a compound represented by the following chemical formula:

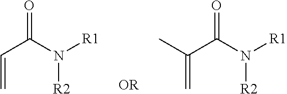

In the above chemical formulas, R1 is H, an alkyl group, a hydroxyalkyl group, or an ether group that has the number of carbon atoms of 1 or more to 6 or less, is linear, branched, or cyclic and includes a cyclic compound with R2. In the above chemical formulas, R2 is H, an alkyl group, a hydroxyalkyl group, or an ether group that has the number of carbon atoms of 1 or more to 6 or less, is linear, branched, or cyclic and includes a cyclic compound with R1.

Further, a preferable example of the common (meth)acrylic monomer is (meth)acryloyl morpholine. (Meth)acryloyl morpholine has high hydrophilicity, high water solubility and high solubility.

Modeling Apparatus

In the present embodiment, the composition A and the composition B are each mounted on a modeling apparatus as a model material or a support material. The following illustrates a typical material jet modeling apparatus using a model material and a support material having UV curability, as a modeling apparatus (an example of a three-dimensional modeling apparatus) suitably used in the manufacturing method of the present embodiment. Examples of such a modeling apparatus include Agilista (manufactured by Keyence Corporation) and Objet 30 (manufactured by Stratasys). Note that the modeling apparatus of the present invention is not limited these examples. For example, a dispenser modeling apparatus may be used instead of the material jet modeling apparatus.

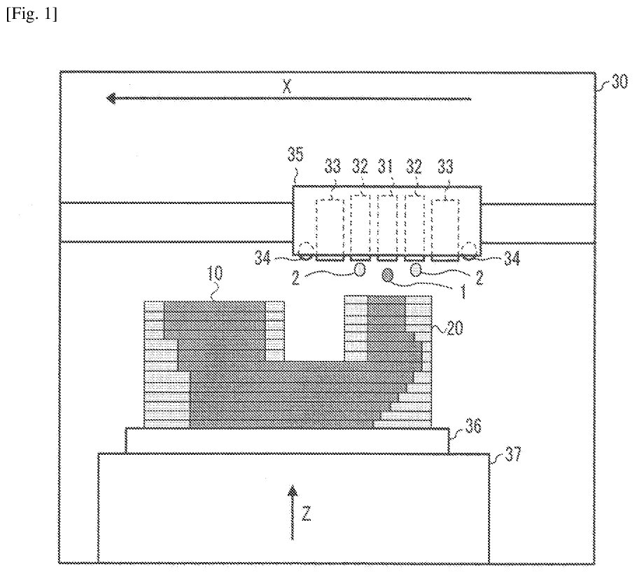

FIG. 1 is a schematic diagram illustrating a modeling apparatus according to an embodiment of the present invention. The modeling apparatus 30 includes head units 31 and 32, ultraviolet irradiators 33, rollers 34, a carriage 35, and a stage 37. The head unit 31 is configured to eject a model material 1. The head unit 32 is configured to eject a support material 2. The ultraviolet irradiators 33 are configured to irradiate the ejected model material 1 and ejected support material 2 with ultraviolet rays to cure the model material 1 and support material 2. The rollers 34 are configured to smooth liquid films of the model material 1 and the support material 2. The carriage 35 is configured to reciprocate each of the head units 31 and 32, and the like in an X direction in FIG. 1. The stage 37 is configured to move a substrate 36 in a Z direction depicted in FIG. 1, and in a Y direction which is a depth direction in FIG. 1.

When there are two or more model materials for different colors, the modeling apparatus 30 may be provided with two or more head units 31 for ejecting the model materials of respective colors.

The head units 31 and 32 are provided with respective storage parts such as subtanks for storing the composition A and the composition B, respectively. The composition A or composition B contained in the head units 31 and 32 may be supplied from other storage parts, respectively. Examples of other storage parts include a cartridge storing the composition A or the composition B and in a casing with a resin or the like, a bottle, and the like. The cartridge may include an aluminum pouch having an inner pouch made of resin such as polyethylene to store the composition A or the composition B. As nozzles in the head units 31 and 32, nozzles used in well-known ink jet printers may be suitably used.

Examples of metals used for the roller 34 include SUS 300 series, SUS 400 series, SUS 600 series, hexavalent chromium, silicon nitride, tungsten carbide and the like. Further, any one of these metals coated with fluorine, silicone or the like may be used for the rollers 34. Among these metals, SUS 600 series is preferable from the viewpoint of strength and processability.

In a case of using the rollers 34, the modeling apparatus 30 laminates layers on the stage 37 while lowering the stage 37 in accordance with the number of layering in order to keep a gap between the rollers 34 and the surface of a model constant. The rollers 34 may preferably be located adjacent to the ultraviolet irradiators 33.

In order to prevent ink from drying while the head units 31 and 32 of the modeling apparatus 30 pause or stop, the modeling apparatus 30 may be provided with covering units such as caps for covering the nozzles of the head units 31 and 32. Further, in order to prevent clogging of the nozzles during continuous use of the modeling apparatus 30 for substantially a long time, the modeling apparatus 30 may be provided with a maintenance mechanism for maintaining the head units.

The ultraviolet irradiators 33 used for curing the model material 1 and the support material 2 are not particularly specified and may be appropriately selected according to the intended use or purpose. Examples of the ultraviolet irradiators 33 include a high-pressure mercury lamp, an ultrahigh pressure mercury lamp, an LED, a metal halide and the like. Although the ultrahigh pressure mercury lamp is a point light source, a deep UV type ultrahigh pressure mercury lamp exhibiting improved light utilization efficiency in combination with an optical system may be capable of short wavelength region irradiation. The metal halide may be selected according to the absorption spectrum of a photopolymerization initiator due to having a wide wavelength region. Specific examples of the ultraviolet irradiators 33 include commercially available ultraviolet irradiators such as H lamp, D lamp, V lamp and the like manufactured by Fusion System Co., Ltd.

Note that the modeling apparatus 30 is preferably a heaterless modeling apparatus that is capable of modeling at room temperature.

Modeling Process

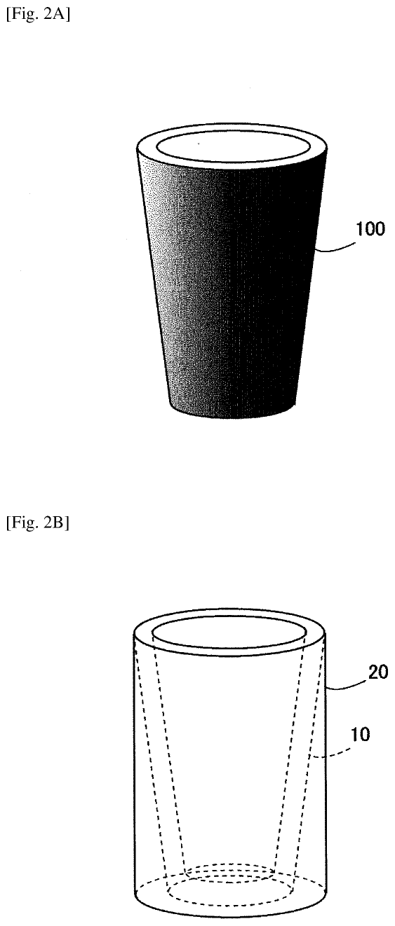

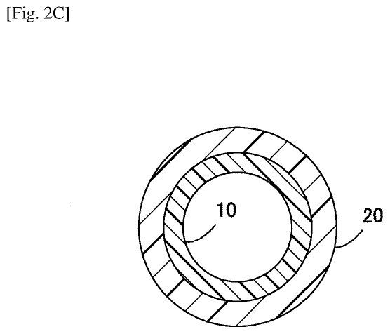

FIGS. 2A to 2C are conceptual diagrams illustrating a process of manufacturing a three-dimensional model. FIG. 2A is a perspective diagram illustrating an example of a three-dimensional model. A three-dimensional model 100 is, for example, three-dimensional data such as a three-dimensional shape designed by three-dimensional CAD, or three-dimensional shape surface data and three-dimensional solid data captured by a three-dimensional scanner or a digitizer. For example, the three-dimensional data may be converted into an STL format (Standard Triangulated Language), which expresses the surface of a three-dimensional model as a triangular aggregate. The three-dimensional data may be input, for example, to an information processing apparatus provided in the modeling apparatus.

The information processing apparatus specifies a bottom surface from the input three-dimensional data. The method of specifying the bottom surface is not particularly specified; an example of such a method includes a method of setting the Z axis for the direction having the shortest length and setting a contact point between a surface orthogonal to the Z axis and the three-dimensional model as the bottom surface when the three-dimensional model is arranged in a three-dimensional coordinate system.

The information processing apparatus generates two-dimensional data indicating a cut plane in which a three-dimensional model is sliced in a direction parallel to the bottom surface at predetermined intervals in the Z axis direction. In this case, the information processing apparatus calculates a projected area on an XY plane, an XZ plane, and a YZ plane of the three-dimensional model. The information processing apparatus cuts (slices) a block shape having the obtained projected areas sectionally with a thickness of one layer in parallel with the XY plane. The thickness of one layer depends on the material to be used, but is usually approximately 20 μm or more and 60 μm or less. Data processing such as generation of two-dimensional data may be automatically executed in the information processing apparatus according to designation of materials to be used.

In a case where the three-dimensional model has an overhang part such as the curved surface depicted by gradation in FIG. 2A, the modeling apparatus shapes the model part while supporting the model part of the overhang part with the support part. FIG. 2B is a perspective diagram illustrating an example of a model having the model part 10 with the overhang part being supported by the support part 20.

The information processing apparatus adds pixels indicating a support part to the bottom side of the overhang part with respect to each generated two-dimensional data. The two-dimensional data finally generated represents one cross section of the model, and includes pixels indicating the model part and pixels indicating the support part. FIG. 2C is a cross-sectional diagram illustrating one section of the model of FIG. 2B.

Ejecting Step

An engine of the modeling apparatus 30 inputs the two-dimensional data generated by the information processing apparatus. While moving the carriage 15 or the stage 37, the engine of the modeling apparatus 30 ejects droplets of the model material 1 from the head unit 31 and ejects droplets of the support material 2 from the head unit 32, based on the two-dimensional data indicating a cross section closest to the bottom surface among the input two-dimensional data. As a result, the droplets of the model material 1 are arranged at positions corresponding to the pixels indicating the model part in the two-dimensional data, which indicates the cross section closest to the bottom surface, and the droplets of the support material 2 are arranged at positions corresponding to the pixels indicating the support part, thereby forming a liquid film composed of droplets that are in contact with one another at adjacent positions.

In a case where there is only one model to be molded, a liquid film having a cross-sectional shape is formed in the center of the stage 37. In a case where there are two or more models to be molded, the modeling apparatus 30 may form two or more liquid films each having a cross-sectional shape on the stage 37, or may layer liquid films on top of a previously model.

Smoothing Step

In a smoothing step, the rollers 34 scrape off excessive parts of the model material and the support material ejected onto the stage 37, thereby smoothing the liquid film composed of the model material and the support material, or smoothing unevenness of a layer. The smoothing step may be performed once every layering or once every 2 to 50 layering in the Z axis direction. In the smoothing step, the rollers 34 may be stopped or may be rotated at a positive or negative relative speed with respect to an advancing direction of the stage 37. Further, the rotational speed of the rollers 34 may be a constant speed, a constant acceleration or a constant deceleration. The rotational speed of the rollers 34 may preferably be 50 mm/s or more and 400 mm/s or less as the absolute value of the relative speed with the stage 37. When the relative speed is too low, the smoothing is insufficient, and hence, smoothness is impaired. When the relative speed is too high, the apparatus needs to be larger; displacement or the like of the ejected droplets may likely occur due to vibration or the like, which as a result may degrade the smoothness.

### Curing Step

In a curing step, the engine of the modeling apparatus 30 moves the ultraviolet irradiators 33 in opposite directions by the carriage 15, such that the liquid film formed in the liquid film forming step is irradiated with ultraviolet rays according to the wavelength of the photopolymerization initiator contained in the model material and the support material. As a result, the modeling apparatus 30 cures the liquid film to form a layer.

Laminate Layers

The engine of the modeling apparatus 30 that has formed the layer closest to the bottom surface lowers the stage 37 by one layer. While moving the carriage 15 or the stage 37, the engine of the modeling apparatus 30 ejects droplets of the model material 1 and droplets of the support material 2, based on the two-dimensional image data indicating a second one of cross sections closest to the bottom surface. The ejection method is the same as that used for forming the liquid film closest to the bottom surface. As a result, a liquid film having a shape of the second closest cross section from the bottom surface indicated by the two-dimensional data is formed on the layer closest to the bottom surface. Furthermore, the engine of the modeling apparatus 30 irradiates the liquid film with ultraviolet rays while moving the ultraviolet irradiators 33 by the carriage 15 to cure the liquid film to thereby form a second layer on the (first) layer closest to the bottom surface.

The engine of the modeling apparatus 30 uses the input two-dimensional data of the layers in a sequential order from the closest to the bottom surface, and repeats the forming and the curing of the liquid film in the same manner as described above to laminate the layers. The repeating number of layering varies with the number of input two-dimensional image data, or with the height, shape, and the like of a 3D model. When modeling by using all the two-dimensional image data is completed, a model of the model part supported by the support part is obtained.

Removal

The model formed by the modeling apparatus 30 has an interface between a cured product of the model material and a cured product of the support material. The support part as a cured product is removed from the model after the model is obtained. Removal methods include physical removal and chemical removal. In the physical removal, a mechanical force is applied to the model, and the support part is peeled from the model part. The method of removing the support part is not particularly specified; however, since this physical removal operation requires a person's hands, the chemical removal using water or a solvent is preferable. To adopt the removal using water, the cured product of the support material having water solubility is selected.

### EXAMPLES

In the following, the present invention will be specifically described with reference to examples and comparative examples; however, the present invention is not limited by these examples.

Preparation of Compositions

80 parts by weight of a-1: isobornyl acrylate (manufactured by Tokyo Kasei Kogyo Co., Ltd.), 5 parts by weight of a-2: acryloyl morpholine (manufactured by KJ Chemicals Corporation), 15 parts by weight of b-1: Photomer 6010 (urethane triacrylate manufactured by BASF), 2 parts by weight of c-1: a polymerization initiator (hydroxycyclohexyl phenyl ketone, trade name: Irgacure 184, manufactured by BASF Co.), and 0.5 parts by weight of d-1: BYK-307 (manufactured by BYK Chemie) were stirred for 30 minutes in a beaker to obtain a composition A1-1.

Compositions A1-2, A1-3, A1-4 and compositions B2-1, B2-2, B2-3, B2-4 were obtained in the same manner as in the preparation of composition A1-1, except that the blending amount was changed as illustrated in Table 1. The numbers and names of test reagents are indicated below.

a-3 hydroxyethyl acrylamide (manufactured by KJ Chemicals)

a-4 N-isopropylacrylamide (manufactured by KJ Chemicals)

a-5 stearyl acrylate (manufactured by Tokyo Chemical Industry Co., Ltd.)

b-2 DCP-A (dimethylol-tricyclodecane diacrylate, manufactured by Kyoeisha Chemical Co., Ltd.)

b-3 polypropylene glycol (Mw 1,000) (manufactured by ADEKA CORPORATION)

b-4 1.5 pentanediol (manufactured by Tokyo Chemical Industry Co., Ltd.)

b-5 1,6 pentanediol (manufactured by Tokyo Chemical Industry Co., Ltd.)

b-6 urethane acrylate oligomer

b-7 Ion exchanged water

c-1 IRG 184 (1-hydroxycyclohexyl phenyl ketone, manufactured by BASF)

c-2 TPO (2,4,6-trimethylbenzoyldiphenylphosphineoxide, manufactured by BASF)

c-3 IRG 2959

(1-[4-(2-Hydroxyethoxy)-phenyl]-2-hydroxy-2-methyl-1-propane-1-one, manufactured by BASF)

d-2 BYK-348 (polyether-modified siloxane, manufactured by BYK Japan KK)

d-3 F-477 (fluorosurfactant, manufactured by Kao Corporation)

The urethane acrylate oligomer of b-6 is produced as follows. 100 parts by weight of caprolactone adduct of 2-hydroxyethyl acrylate [trade name “PLACCEL FA-4D”, manufactured by Daicel Chemical Industries, Ltd., addition molar number 4], 64 parts by weight of polyisocyanurate products (IPDI) (trade name “VESTANATT 1890”, manufactured by Degussa Japan Co., Ltd.), and 0.03 parts by weight of a urethanization catalyst [bismuth tri(2-ethylhexanoate) (2-ethylhexanoic acid 50% solution)] was charged in a reaction vessel and reacted at 80° C. for 12 hours to obtain a urethane acrylate oligomer. The Mn of the urethane acrylate oligomer is 1,730.

Table 1 indicates hSP values of components a-1, a-2, a-3, a-4 and a-5; b-1, b-2, b-3, b-4, b-5, b-6 and b-7; and c-1, c-2 and c-3. Table 1 also indicates the weight average hSP value of each composition calculated from the hSP value of the corresponding component. The unit of hSP values in Table 1 is MPa^{0.5}. In addition, the unit of the blending amount in Table 1 is parts by weight.

The results of measuring the surface tension of the compositions by the method described in the above-described embodiment are illustrated in Table 1. The unit of surface tension in Table 1 is mN/m.

TABLE 1

| | | hSP | A | | | | B | | | |
|---|---|---|---|---|---|---|---|---|---|---|
| | | VALUE | 1-1 | 1-2 | 1-3 | 1-4 | 2-1 | 2-2 | 2-3 | 2-4 |
| a | a-1 | 19.7 | 80 | 40 | 60 | 70 | | | | |
| | a-2 | 26.0 | 5 | 10 | | | 45 | 50 | 35 | 40 |
| | a-3 | 29.3 | | | 2 | | | | 10 | |
| | a-4 | 21.5 | | 10 | 3 | | | | 5 | |
| | a-5 | 8.7 | | 10 | 10 | | | | | |
| b | b-1 | 21.7 | 15 | 20 | 15 | | | | | |
| | b-2 | 20.3 | | 10 | 5 | 10 | | | | |
| | b-3 | 15.2 | | | | | 48 | 44 | 50 | |
| | b-4 | 27.6 | | | | | 7 | | | |
| | b-5 | 25.2 | | | | | | 4 | 4 | |
| | b-6 | 21.9 | | | | 20 | | | | |
| | b-7 | 47.8 | | | | | | | | 60 |
| c | c-1 | 25.0 | 2 | 2 | 2 | | 2 | 2 | 2 | |
| | c-2 | 21.9 | | | | 5 | | | | |
| | c-3 | 25.4 | | | | | | | | 5 |
| d | d-1 | | 0.5 | | | 0.1 | 0.8 | | | |
| | d-2 | | | 0.005 | | | | 0.15 | | |
| | d-3 | | | | 0.01 | | | | | |
| hSP VALUE | | | 20.4 | 20.0 | 19.2 | 20.3 | 21.0 | 21.2 | 21.0 | 38.4 |
| SURFACE | | | 28.2 | 35.1 | 35.3 | 30.8 | 29.5 | 33.4 | 36.2 | 37.1 |
| TENSION | | | | | | | | | | |

### Example 1

Modeling evaluation was performed by using a set of composition A and composition B of Example 1 illustrated in Table 2.

### Modeling Three-Dimensional Models

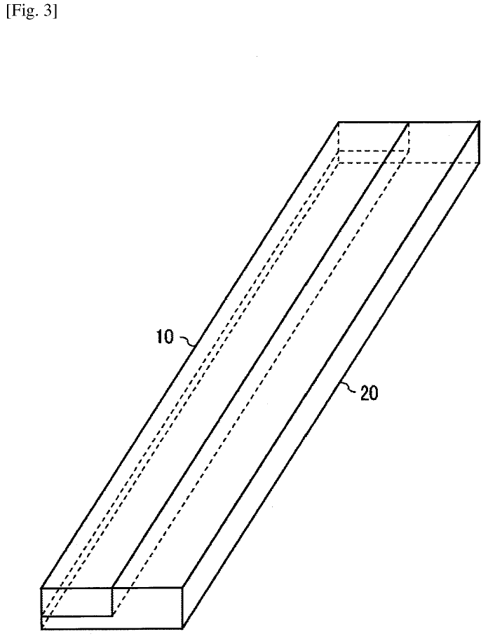

In a sealed cover, a model depicted in FIG. 3 was formed using the modeling apparatus depicted in FIG. 1. FIG. 3 is a perspective diagram illustrating an example of a model. In FIG. 3, the model part 10 is formed by the composition A1-1, and the support part 20 is formed by the composition B2-1. The size of the model (total) is 10 mm×100 mm×5 mm, and the size of length×width×height of the model part 10 is 5 mm×100 mm×4 mm.

In the material jet type modeling apparatus 30 of FIG. 1, a GEN 4 head (manufactured by Ricoh Company, Ltd.) was used as a head; the power frequency was set to 1 kHz, the ejection amount per one drop was adjusted to 20 to 25 pL, and the composition A1-1 and the composition B2-1 were used for modeling. For the ejection amount per droplet, the mass per droplet was calculated from the mass ejected at 8 kHz for 5 minutes.

The rotation speed of the rollers 34 in the modeling apparatus 30 was set such that a relative speed with respect to the stage 37 was 500 mm/s. Furthermore, the liquid film formed by the ejected composition A1-1 and composition B2-1 were cured by being irradiated with ultraviolet rays at an irradiation dose of 200 mJ/cm², using an ultraviolet irradiation device (device name: SubZero-LED, manufactured by Integration Technology Co., Ltd.). The above-described liquid film was formed and cured repeatedly to obtain a three-dimensional model.

### Examples 2 to 8 and Comparative Examples 1 and 8

Models in Examples 2 to 8, and in Comparative Example 1 to 8 were obtained in the same manner as in Example 1, except that the set of the composition A and the composition B, and the rotational speed of the rollers 34 were changed as illustrated in Tables 2 to 5. In Tables 2 to 5, the unit of the rotational speed of rollers is mm/s. In Tables 2 to 5, |Spa−SPb| represents the absolute value of the difference between the hSP value of the composition A and the hSP value of the composition B, and the unit of the hSP values is MPa^{0.5}. In Tables 2 to 5, |STa−STb| represents the absolute value of the difference between the surface tension of the composition A and the surface tension of the composition B.

The models produced in Examples 1 to 8 and in Comparative Examples 1 to 8 were subjected to the following evaluations.

Smoothness

The smoothness may be evaluated based on the surface roughness Ra by a laser microscope. As the laser microscope, the VX series manufactured by Keyence Corporation and the like may be given. With respect to each of the models of Examples and Comparative Examples, the support part 20 was peeled off from the model, and the surface roughness Ra of an adhesive interface of the model part 10 was evaluated based on the following evaluation criteria. The surface roughness Ra is preferably 10 or less.

### Evaluation Criteria

### POOR: 10 OR MORE

### SATISFACTORY: LESS THAN 10 AND 6 OR MORE

### EXCELLENT: LESS THAN 6

### Removability of Support Part

The obtained model was placed in a beaker, and 100 mL of tap water was subsequently poured into the beaker to immerse the three-dimensional model. The immersed model was then left to stand for 1.5 hours, and taken out from the beaker, thereby obtaining a model part 10. Water was wiped from the obtained model part 10, and the model part 10 was then observed visually, and the “removability of the support part” was evaluated based on the following evaluation criteria. The evaluation result being “EXCELLENT”, or “SATISFACTORY” indicates that the support part had water disintegratability.

Evaluation Criteria

EXCELLENT: NO SUPPORT PART RESIDUE IN MODEL PART

SATISFACTORY: SMALL AMOUNT OF SUPPORT PART RESIDUE IN MODEL PART (20 VOL % OR LESS OF SUPPORT PART RESIDUE)

POOR: SUBSTANTIAL AMOUNT OF SUPPORT PART RESIDUE IN THE MODEL PART (20 VOL % OR MORE OF SUPPORT PART RESIDUE)

In Example 2, the transparency was improved by adjusting the SP value. Further, the smoothness was improved by changing the rotational speed of the rollers 34 by a factor of 1/10.

In Example 3, acryloyl morpholine of Example 1 was changed to hydroxyethyl acrylamide and N-isopropyl acrylamide, and the result indicated excellent transparency as in Example 1. Further, the smoothness was improved by changing the rotation speed of the rollers 34 by a factor of 1/10 in the reverse direction of rotation.

In Comparative Examples 1 to 8, the surface tension difference (|STa−STb|) was large, and smoothness and transparency decreased.

TABLE 2

| | EXAMPLE | | | |
|---|---|---|---|---|
| | 1 | 2 | 3 | 4 |
| RESIN COMPOSITION A | 1-1 | 1-2 | 1-2 | 1-2 |
| RESIN COMPOSITION B | 2-1 | 2-2 | 2-3 | 2-4 |
| \|SPa − SPb\| | 0.6 | 1.2 | 1.0 | 18.4 |
| \|STa − STb\| | 1.3 | 1.7 | 1.1 | 2.0 |
| ROLLER ROTATIONAL | 500 | 50 | −50 | −400 |
| SPEED | | | | |
| SMOOTHNESS | SATISFACTORY | EXCELLENT | EXCELLENT | EXCELLENT |
| REMOVABILITY OF | EXCELLENT | EXCELLENT | EXCELLENT | EXCELLENT |
| SUPPORT PART | | | | |

TABLE 3

| | EXAMPLE | | | |
|---|---|---|---|---|
| | 5 | 6 | 7 | 8 |
| RESIN COMPOSITION A | 1-3 | 1-3 | 1-3 | 1-4 |
| RESIN COMPOSITION B | 2-2 | 2-3 | 2-4 | 2-1 |
| \|SPa − SPb\| | 2.0 | 1.7 | 19.2 | 0.8 |
| \|STa − STb\| | 1.9 | 0.9 | 1.8 | 1.3 |
| ROLLER ROTATIONAL | 300 | 50 | 50 | 0 |
| SPEED | | | | |
| SMOOTHNESS | EXCELLENT | EXCELLENT | EXCELLENT | EXCELLENT |
| REMOVABILITY OF | EXCELLENT | EXCELLENT | EXCELLENT | SATISFACTORY |
| SUPPORT PART | | | | |

TABLE 4

| | COMPARATIVE EXAMPLE | | | |
|---|---|---|---|---|
| | 1 | 2 | 3 | 4 |
| RESIN COMPOSITION A | 1-1 | 1-1 | 1-1 | 1-2 |
| RESIN COMPOSITION B | 2-2 | 2-3 | 2-4 | 2-1 |
| \|SPa − SPb\| | 0.8 | 0.6 | 18.0 | 1.0 |
| \|STa − STb\| | 5.2 | 8.0 | 8.9 | 5.6 |
| ROLLER ROTATIONAL | 0 | 0 | 500 | −500 |
| SPEED | | | | |
| SMOOTHNESS | POOR | SATISFACTORY | POOR | POOR |
| REMOVABILITY OF | SATISFACTORY | POOR | SATISFACTORY | SATISFACTORY |
| SUPPORT PART | | | | |

TABLE 5

| | COMPARATIVE EXAMPLE | | | |
|---|---|---|---|---|
| | 5 | 6 | 7 | 8 |
| RESIN COMPOSITION A | 1-3 | 1-4 | 1-4 | 1-4 |
| RESIN COMPOSITION B | 2-1 | 2-2 | 2-3 | 2-4 |
| \|SPa − SPb\| | 1.8 | 0.9 | 0.7 | 18.2 |
| \|STa − STb\| | 5.8 | 2.6 | 5.4 | 6.3 |
| ROLLER ROTATIONAL | 50 | 0 | 500 | 0 |
| SPEED | | | | |
| SMOOTHNESS | EXCELLENT | POOR | SATISFACTORY | POOR |
| REMOVABILITY OF | SATISFACTORY | POOR | POOR | SATISFACTORY |
| SUPPORT PART | | | | |

### REFERENCE SIGNS LIST

1 model material
2 support material
10 model part
20 support part
30 modeling apparatus
31 head unit (example of ejection unit)
32 head unit (example of ejection unit)
33 ultraviolet irradiator (example of curing unit)
34 rollers
35 carriage
36 substrate
37 stage
100 three-dimensional model
   The present application is based on and claims the benefit of priority of Japanese Priority Application No. 2017-065570 filed on Mar. 29, 2017, the entire contents of which are hereby incorporated herein by reference.

1. A three-dimensional modeling composition set, comprising:
a first composition; and
a second composition,
wherein at least one of a cured product of the first composition and a cured product of the second composition has water disintegratability, and
wherein when ST1 represents surface tension of the first composition and ST2 represents surface tension of the second composition, the following formulas (1) and (3) are satisfied:

|ST1−ST2|≤2 (1)
33≤ST2≤40 (3)
wherein in the formulas (1) and (3), the unit of the surface tension is mN/m.

2. The three-dimensional modeling composition set according to claim 1,
wherein the following formulas (2) is satisfied:
28≤ST1≤40 (2)
wherein in the formula (2), the unit of the surface tension is mN/m.

3. The three-dimensional modeling composition set according to claim 1,
wherein the difference between a weight average hSP value of the first composition and a weight average hSP value of the second composition is 1.3 MPa^{0.5} or more.

4. The three-dimensional modeling composition set according to claim 1,
wherein at least one of the first composition and the second composition is an active energy ray curable composition.

5. The three-dimensional modeling composition set according to claim 1,
wherein as the water disintegratability, at least one of the following conditions A to C is satisfied,
wherein the condition A indicates that when a cured product of 20 mm in length×20 mm in width×5 mm in height obtained by being irradiated with active energy rays at 500 mJ/cm² is placed in 20 mL of water, and ultrasonic waves are applied to the cured product for 30 minutes at either 40° C. or 60° C., a volume of a residual solid is less than 30 vol %,
the condition B indicates that when a cured product of 20 mm in length×20 mm in width×5 mm in height obtained by being irradiated with active energy rays at 500 mJ/cm² is placed in 20 mL of water and left to stand at 25° C. for 1 hour, a volume of a residual solid is 90 vol % or less, and
the condition C indicates that when a cured product of 20 mm in length×20 mm in width×5 mm in height obtained by being irradiated with active energy rays at 500 mJ/cm² is placed in 20 mL of water and left to stand at 25° C. for 1 hour, a resulting solid has a size of at least one side being 1 mm or less, or the resulting solid has completely dissolved.

6. The three-dimensional modeling composition set according to claim 1,
wherein the first composition and the second composition contain a common (meth)acrylic monomer or a common (meth)acrylamide monomer.

7. The three-dimensional modeling composition set according to claim 6,
wherein the first composition and the second composition include monomers represented by the following chemical formula: 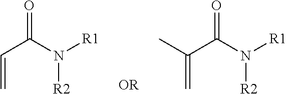
wherein in the chemical formulas, R1 is H, an alkyl group, a hydroxyalkyl group, or an ether group that has the number of carbon atoms of 1 or more to 6 or less, is linear, branched, or cyclic and includes a cyclic compound with R2, and
wherein R2 is H, an alkyl group, a hydroxyalkyl group, or an ether group that has the number of carbon atoms of 1 or more to 6 or less, is linear, branched, or cyclic and includes a cyclic compound with R1.

8. The three-dimensional modeling composition set according to claim 7,
wherein the first composition and the second composition include (meth)acryloyl morpholine.

9. The three-dimensional modeling composition set according to claim 1,
wherein at least one of the first composition and the second composition includes a surfactant.

10. A method for manufacturing a three-dimensional model, the method comprising:
ejecting a first composition and a second composition to form a liquid film having an interface between the first composition and the second composition;
curing the liquid film to form a layer; and
repeating the ejecting step and the curing step to laminate the layers,
wherein at least one of a cured product of the first composition and a cured product of the second composition has water disintegratability, and
wherein when ST1 represents surface tension of the first composition and ST2 represents surface tension of the second composition, the following formulas (1) and (3) are satisfied:

|ST1−ST2|≤2 (1)
33≤ST2≤40 (3)
wherein in the formulas (1) and (3), the unit of the surface tension is mN/m.

11. The method according to claim 10, further comprising:
smoothing the ejected first composition and the ejected second composition by a roller,
wherein the rotational speed of the roller is 50 mm/s or more and 400 mm/s or less.

12. A three-dimensional modeling apparatus comprising:
a first storage storing a first composition;
a second storage storing a second composition;
an ejection unit configured to eject the first composition and the second composition to form a liquid film having an interface between the first composition and the second composition; and
a curing unit configured to cure the liquid film to form a layer,
wherein formation of the liquid film and formation of the layer are repeated to laminate the layers,
wherein at least one of a cured product of the first composition and a cured product of the second composition has water disintegratability, and
wherein when ST1 represents surface tension of the first composition and ST2 represents surface tension of the second composition, the following formulas (1) and (3) are satisfied:

|ST1−ST2|≤2 (1)
33≤ST2≤40 (3)
wherein in the formulas (1) and (3), the unit of the surface tension is mN/m.

13. The three-dimensional modeling composition set according to claim 1, wherein
the first composition includes a surfactant and the second composition does not include a surfactant.
